(19) United States
(12) Patent Application Publication
(10) Pub. No.: US 2005/0042049 A1
(43) Pub. Date: Feb. 24, 2005

(54) Screw-tap for cutting female threads

(75) Inventor: Friedrich Schwarz, Schwanau (DE)

Correspondence Address: BURNS DOANE SWECKER & MATHIS L L P, POST OFFICE BOX 1404, ALEXANDRIA, VA, 22313-1404, US

(73) Assignee: SANDVIK AB, Sandviken (SE)

(21) Appl. No.: 10/893,366

(22) Filed: Jul. 19, 2004

(30) Foreign Application Priority Data
Jul. 19, 2003 (DE) 103 32 930.7

(51) Int. Cl. B23G 5/06

(52) U.S. Cl. 408/222

(57) ABSTRACT

A screw-tap includes at least two cutting lands with respective cutting edges. The cutting edges have, at least in a starting taper region thereof, a chamfer with a negative angle that reduces a rake angle of the cutting edges. An angle of the chamfer to a plane oriented perpendicular to a surface produced in a workpiece has a value in a range of −10° and −60°. A width of the chamfer is between 0.05 and 0.75 times a depth of profile.

This application claims priority under 35 U.S.C. §§ 119 and/or 365 to Patent Application Serial No. 103 32 930.7 filed in Germany on Jul. 19, 2003, the entire content of which is hereby incorporated by reference.

### BACKGROUND OF THE INVENTION

The present invention relates to a screw-tap for cutting female threads, with at least two lands having cutting edges, as well as to a method of cutting female threads in a workpiece.

Screw-taps in a variety of forms for cutting female threads are known from the state of the art.

The design of the tap is primarily determined by the different kinds of thread that can be produced with taps. ISO metric threads for precision engineering, tight-fitting threads, loose-fitting threads, taper threads, pipe threads, Whitworth pipe threads, trapezoidal threads, buttress threads, rounded threads, tapping-screw threads, etc. each need a special screw-tap for the specific application in order to yield an optimal result. The configuration of the tool is additionally determined by the runout of the hole.

The design of screw-taps is increasingly determined by the requirement for high cutting speeds. Where a thread used to be tapped by hand with a three-piece set of taps, it can now be cut by machine with a single tap. To obtain higher throughputs on the machines, cutting speeds of up to 100 m/min are possible. That necessitates the use of screw-taps made from hard metals, coated or uncoated.

The likelihood of breaks and spalling of the tool, and hence the process reliability achieved with a given tool depends, especially at the required high cutting speeds, on the rate of transport of the chips out of the hole. Both the geometry of the chip grooves and the geometry of the cutting edges biting into the workpiece have a bearing on the transport of the chips out of the hole. Whereas it is the geometry of the chip grooves that causes the chips to be transported out of the hole, the geometry of the cutting edges determines the breaking and curling of the chips and hence the transport characteristics of the chips to be conveyed out of the hole.

Depending on the material to be drilled, rake angles for screw-taps ranging from −20° to +20° are known from the state of the art. The rake angle primarily determines the chip form (continuous chips with built-up edge, discontinuous chips, or continuous chips), and affects the cutting torque. The chip form, in turn, determines the transport characteristic of the chips.

At the sought-after high cutting speeds, all known screw-taps have reached their limits in terms of the normal requirements for tool life in modern production processes. Because of inadequate transport of chips out of the hole, spalling of the cutting edges, or even breaks of the taps, frequently occur, especially at high cutting speeds.

It is an object of the present invention with respect to the state of the art to provide a screw-tap affording adequate process reliability, even at very high cutting speeds.

### SUMMARY OF THE INVENTION

In accordance with the invention this object is solved by providing a screw-tap with at least two cutting edges wherein the cutting edges have, a least in the starting taper, a cutting-edge chamfer with a negative angle that reduces the effective rake angle of the cutting edges. Preferably, an angle of the chamfer to a surface produced in a workpiece has a value in a range of −10° and −60°.

Preferably, a width of the chamfer is between 0.05 and 0.75 times a depth of profile.

The surface of the cutting-edge chamfer makes a negative angle with the perpendicular to the surface produced by the cut. This means the cutting edge is formed as the transition from the flank to the surface of the chamfer, and not from the root of the chip groove to the flank as in state-of-the-art taps.

One advantage of the screw-tap according to the invention is that because of the negative geometry of the chamfer, the chips produced by the cutting edge are curled more tightly, or break away sooner, than when using a geometry with a wholly positive rake angle. As a result, the chips form units which are more compact and often smaller, and which can be conveyed more readily out of the hole.

The overall geometry of the screw-tap may be either positive or negative. That is to say, the rake angle included by the cutting face and the perpendicular to the surface produced by the cut may have a positive or negative value. Since the positive or negative geometry of the tap immediately adjacent to the chamfer, apart from the chamfer with a negative angle, is retained, the chips can still be removed in the manner appropriate to the workpiece concerned. The terms “positive” and “negative” should be understood in the context of the usual designations for cutting edge geometries or rake angle referred to above.

When designing the geometry of the screw-tap according to the invention, it is advantageous that the angle of the chamfer should have a value of between −10° and −60°, preferably a range of −30° to 45° and most preferably a value of −35°, the angle being measured between the surface of the chamfer and a plane perpendicular to a surface produced in the workpiece by the cut. For most important materials, chip formation that is optimal for chip transport is obtained with these angles.

An embodiment of the invention is preferred in which the width of the chamfer measured in the direction of the radial pitch is between 0.05 times and 0.75 times the depth of profile, preferably between 0.1 or 0.2 times and 0.5 times the depth of profile. Depth of profile denotes the radial distance from the diameter of the thread core to the outer diameter of the tap. By virtue of this limitation of the width of the chamfer, or of the regions of the cutting face which include a negative angle with the perpendicular to the surface produced, the positive or negative overall chip-deflecting geometry of the tap is retained.

In a preferred embodiment of the invention, this chamfer additionally extends to the cutting edges in the region of the guide part. Early chip-breakaway and curling of the chips are then also obtained when engagement of cutting edges located in the region of the guide part of the tap occurs. Hence the transport characteristics of chips cut by the guide part of the tap are also improved.

Also advantageous is an embodiment of the invention in which the width of the chamfer increases from the tip of the screw-tap towards the shank.

In an especially preferred embodiment, the screw-tap is made from hard metal.

### DESCRIPTION OF THE DRAWINGS

Further advantages, features and possible applications of the present invention will become apparent from the following description, given by way of example, of a preferred embodiment, and the associated figures, in which:

FIG. 1 is An end view from below through the starting taper of the screw-tap according to the invention,

FIG. 2 is an enlarged view of the region of the cross-section of the tap marked with a circle in FIG. 1,

FIG. 3 is a side view of the screw-tap, and

FIG. 4 is a three-dimensional representation of a section of the starting taper region of the tap.

### DESCRIPTION OF PREFERRED EMBODIMENTS OF THE INVENTION

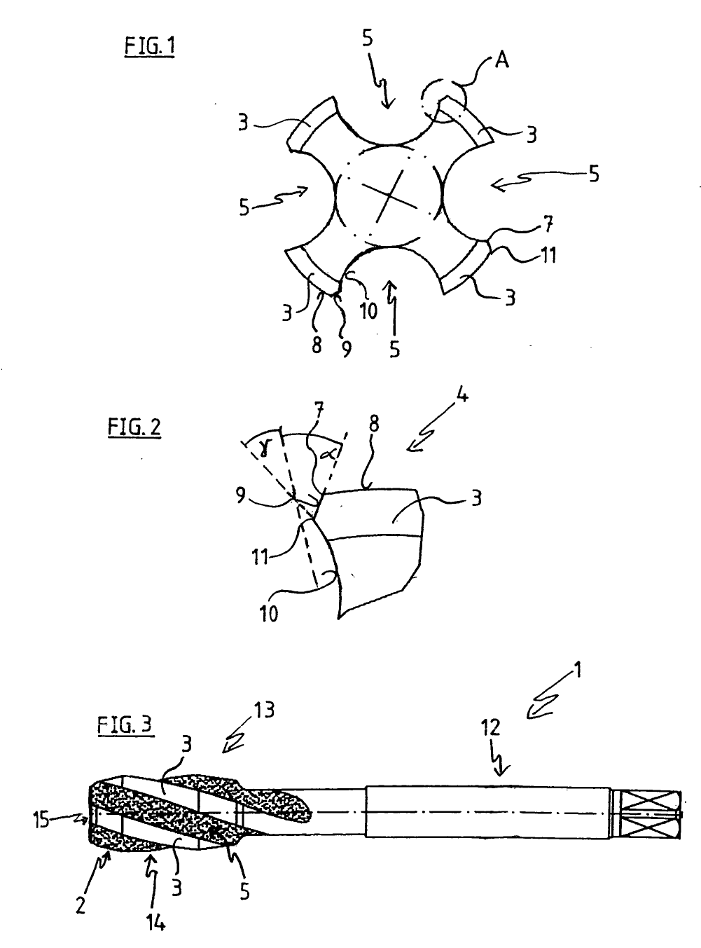

FIG. 1 shows an end view of the screw-tap 1 according to the invention in the region of the starting taper 2. Four cutting lands 3, each with its cutting edge 7 located in the radially outer left-hand region, can be seen. Between the lands 3 there are chip grooves 5 through which the chips are carried away. Depending on the type of hole, the chip grooves 5 may be designed as straight grooves (for working in through bores) or, as in the illustrated embodiment, with positive twist (for working in blind holes). The positive twist of the chip grooves 5 in the illustrated embodiment can be clearly seen in FIG. 3. Chip grooves with no twist are shown in FIG. 1. Alternatively, the chip grooves could have a slight negative twist.

As suggested in FIG. 1, the cutting lands are ground in their radially outer region. Each channel of the screw-tap cuts into the workpiece material to a specific depth, i.e., the depth of cut. The depth of cut generally corresponds to the depth of profile of the tap.

The region of the cutting edges which inwardly limits the radial height of the screw threads and corresponds to the inside thread diameter is designated by way of example by the circle A in FIG. 1 on one cutting land 3. The detail of FIG. 1 corresponding to the circle A is shown enlarged in FIG. 2. The region of the cutting edge 7 of the cutting land 3 is clearly seen. In its radial outer region, the cutting edge shows a ground face. Metal cutting primarily occurs as the tap bites into the workpiece by means of the cutting edges 7. These are formed where the cutting faces 10 and flanks 8 meet. A feature which is crucial to the successful working of the screw-tap is that the flank 8, which is curved in the case of a screw-tap, has a larger radius in the region of the cutting edge 7 than on the side of the land remote from the cutting edge 7. This curvature of the flank is called the relief. The increasing tangential angle thus formed between the surface produced by the cut and the flank 8, the so-called relief angle, prevents the tool from jamming in the workpiece. The chamfer 9 according to the invention on the cutting face 10 in the region of the cutting edge 7 is configured so that the surface of the chamfer 9 makes a negative angle with the perpendicular to the surface produced by the cut. In the illustrated embodiment the angle between the surface of the chamfer 9 and the perpendicular to the surface produced by the cut is about −40°. It is advantageous that the angle of the chamfer should have a value of between −10° and −60°, a range of −30° to −45° being preferred and a value of some −35° being particularly preferred, the angle being measured between the surface of the chamfer and a plane oriented perpendicular to the surface produced in the workpiece by the cut. For most important materials, chip formation that is optimal for chip transport is obtained with these angles.

An embodiment of the invention is preferred in which the width of the chamfer measured in the direction of the radial pitch is between 0.05 times and 0.75 times the depth of profile. Depth of profile means the radial distance from the diameter of the thread core to the outer diameter of the tap. By virtue of this limitation of the width of the chamfer, or of the regions of the cutting face which include a negative angle with the perpendicular to the surface produced, the positive or negative overall chip-deflecting geometry of the tap is retained.

The overall geometry of the cutting edge 7 is, however, still defined by the positive rake angle formed by the cutting face 10 and the flank 8. The chamfer 9 with its negative angle only makes an effective reduction in the rake angle over a relatively small depth of cut. Where the cutting face 10 and flank 9 meet, a further edge, designated by the reference number 11 in FIG. 2, is formed. The chip is carried away, and curled very tightly and/or broken, over this edge 11.

The entire screw-tap 1 is shown in side view in FIG. 3. The screw-tap 1 is divided into a shank 12 by which the tap is held in the chuck, and a cutting part 13 which bites into the workpiece. The cutting region 13 of the screw-tap 1 can be subdivided into the so-called starting taper 2 and the guide part 14. The starting taper 2, the cross-section of which is shown in FIGS. 1 and 2, tapers towards the head 15 of the tap 1. This taper, and the increase in radial pitch as the depth of penetration of the tap into the material increases, limit the volume of material to be removed by each cutting edge 7. The circumference of the tap 1 is greatest at the transition between the starting taper 2 and the guide part 14. The guide part 14 again has a tapered form, but grows narrower towards the shank. This prevents the guide part 14 from jamming in the workpiece and damaging the thread or reducing its surface quality.

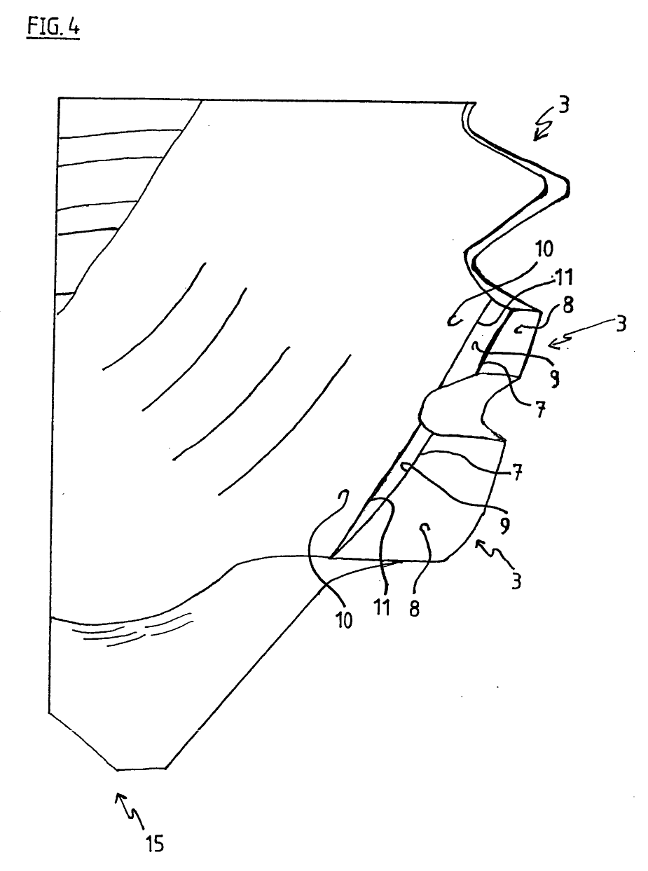

FIG. 4 shows a three-dimensional section of the screw-tap 1 according to the invention. The tapered form of the starting taper 2 of the tap 1, with the depth of profile of the cutting lands 3 increasing with increasing depth of penetration, can be clearly seen. In the embodiment shown, the width of the chamfer 9 also increases with increasing depth of penetration. The overall cutting geometry is positive, so that the wedge angle between the extensions of the flanks 8 and cutting faces 10 is less than 90°, while the chamfer face includes an angle of distinctly more than 90° with the flank.

Although the present invention has been described in connection with preferred embodiments thereof, it will be appreciated by those skilled in the art that additions, deletions, modifications, and substitutions not specifically described may be made without departing from the spirit and scope of the invention as defined in the appended claims.

1. Screw-tap comprising at least two cutting lands with respective cutting edges, wherein the cutting edges have, at least in a starting taper region thereof, a chamfer with a negative angle that reduces a rake angle of the cutting edges, wherein an angle of the chamfer to a plane oriented perpendicular to a surface produced in a workpiece has a value in a range of −10° to −60°.

2. The screw-tap according to claim 1 wherein an overall cutting geometry of the screw-tap, disregarding the chamfer, is positive.

3. The screw-tap according to claim 1 wherein an overall cutting geometry of the screw-tap, disregarding the chamber, is negative.

4. The screw-tap according to claim 4 wherein the range is −30° to 45°.

5. The screw-tap according to claim 4 wherein the value is substantially −35°.

6. The screw-tap according to claim 1 wherein the chamfer additionally extends to at lest part of the cutting edges in the region of the guide part.

7. The screw-tap according to claim 1 wherein a width of the chamfer in the starting taper region increases from the tip of the screw-tap towards the shank.

8. The screw-tap according to claim 1 wherein the screw-tap is made of hard metal.

9. Screw-tap comprising at least two cutting lands with respective cutting edges, wherein each cutting edge has at least in a starting taper region thereof, a chamfer with a negative angle that reduces a rake angle of the cutting edge, wherein a width of the chamfer is between 0.05 and 0.75 times a depth of profile.

10. The screw-tap according to claim 9 wherein the w9idth is between 0.25 and 0.5 times the depth of profile.

11. The screw-tap according to claim 9 wherein a width of the chamfer in the starting taper region increases from the tip of the screw-tap towards the shank.
